(19) United States
(12) Patent Application Publication
(10) Pub. No.: US 2011/0186265 A1
(43) Pub. Date: Aug. 4, 2011

(54) ATTACHMENT ARRANGEMENT FOR A HEAT SINK

(75) Inventors: YUNQI ZHENG, TORRANCE, CA (US); VICENTIU GROSU, HARBOR CITY, CA (US); KHIET LE, MISSION VIEJO, CA (US); MARK D. KORICH, CHINO HILLS, CA (US)

(73) Assignee: GM GLOBAL TECHNOLOGY OPERATIONS, INC., DETROIT, MI (US)

(21) Appl. No.: 12/700,422

(22) Filed: Feb. 4, 2010

(51) Int. Cl. F28F 9/00; B29C 65/52

(52) U.S. Cl. 165/80.1; 156/60

(57) ABSTRACT

An attachment arrangement for a heat sink includes, but is not limited to, an attachment surface defined on the heat sink. A thermally conductive adhesive is disposed on the attachment surface. A substrate is attached to the attachment surface via the thermally conductive adhesive. The thermally conductive adhesive defines a discontinuity that is disposed in a delamination path of the thermally conductive adhesive.

### TECHNICAL FIELD

The technical field generally relates to an attachment arrangement, and more particularly relates to an attachment arrangement for attaching items to a heat sink.

### BACKGROUND

Heat sinks are used in a wide variety of applications to draw heat away from a body, machine and/or an electrical component that gets hot during operation and that can fail if a certain temperature is exceeded. A power electronic module that is used to convert power from a vehicle battery to an electric motor in a hybrid-electric vehicle is an example of a body, machine and/or electrical component that gets hot during normal operations and which needs to be cooled to ensure continuous, reliable, and/or efficient performance. Heat sinks are commonly used to draw heat away from power electronic modules to maintain their temperatures at acceptable levels during normal operations.

An exemplary power electronic module is illustrated in cross section in FIG. 1 and includes one or more semiconductors 20 bonded to a substrate 22. Substrate 22 is attached to a heat sink 24 via a thermally conductive adhesive 26 (e.g., solder) placed on an attachment surface 28 of heat sink 24. Heat sink 24 includes multiple channels 30 through which coolant is pumped. The flow of coolant through channels 30 reduces the temperature of heat sink 24 and, in turn, reduces the temperature of substrate 22 and semiconductors 20.

Because substrate 22 and heat sink 24 are made from different materials, they will generally exhibit different coefficients of thermal expansion. During temperature cycling (e.g., during normal operation), this difference in thermo-mechanical characteristics can produce significant strain within conductive adhesive 26 and at its interfaces to heat sink 24 and substrate 22. Over time, such repetitive strain may lead to fatigue cracking and/or delamination of conductive adhesive 26.

FIG. 2, which depicts a plan view of heat sink 24 and of thermally conductive adhesive 26, illustrates an early stage of the delamination of thermally conductive adhesive 26 from attachment surface 28. As illustrated, corners 32 of thermally conductive adhesive 26 delaminate first. This is because corners 32 are the furthest from the center of thermally conductive adhesive 26 and consequently experience the greatest strain force as substrate 22 and heat sink 24 expand and contract at differing rates. It has been observed that once the corners have delaminated, the delamination then spreads towards the center of thermally conductive adhesive 26. In some examples, once the delaminated area of thermally conductive adhesive 26 reaches approximately 16% of the overall surface area of thermally conductive adhesive 26, there is no longer a sufficient thermal connection between substrate 22 and heat sink 24 to effectively drain heat from substrate 22.

Accordingly, it is desirable to extend the period of time for which a heat sink can effectively control the temperature of a component. Additionally, it is desirable to slow down the delamination of thermally conductive adhesive 26 from such heat sinks. Furthermore, other desirable features and characteristics will become apparent from the subsequent detailed description and the appended claims, taken in conjunction with the accompanying drawings and the foregoing technical field and background.

### SUMMARY

Various non-limiting embodiments of an attachment arrangement for a heat sink and a method of making the attachment arrangement are disclosed herein. In a first non-limiting embodiment, the attachment arrangement includes, but is not limited to, an attachment surface defined on the heat sink. A thermally conductive adhesive is disposed on the attachment surface. A substrate is attached to the attachment surface via the thermally conductive adhesive. In this first non-limiting embodiment, the thermally conductive adhesive defines a discontinuity that is disposed in a delamination path of the thermally conductive adhesive.

In a second non-limiting embodiment, an attachment arrangement for a heat sink includes, but is not limited to, an attachment surface defined on the heat sink. A thermally conductive adhesive is disposed on the attachment surface. The thermally conductive adhesive forms a plurality of segments, each of the segment being spaced apart from one another. A barrier is disposed between each segment of the plurality of segments. A substrate is attached to the attachment surface via the thermally conductive adhesive.

In a third non-limiting embodiment, a method for attaching an item to a heat sink is disclosed. The method includes, but is not limited to the steps of positioning a barrier on an attachment surface of the heat sink, depositing a thermally conductive adhesive on the attachment surface of the heat sink in a pattern that forms a first segment enclosed within the barrier and a second segment disposed outside of the barrier, and disposing a substrate adjacent the thermally conductive adhesive.

### DESCRIPTION OF THE DRAWINGS

One or more embodiments will hereinafter be described in conjunction with the following drawing figures, wherein like numerals denote like elements, and

FIG. 1 is a cross-sectional view of a prior art attachment arrangement connecting a heat sink to an electrical component;

FIG. 2 is a plan view of the heat sink shown in FIG. 1 with the electrical component removed to show a delamination pattern of the prior art attachment arrangement;

FIG. 3-14 illustrate multiple non-limiting embodiments of an attachment arrangement for attaching a substrate to a heat sink according to the present disclosure; and

FIG. 15 is a block diagram illustrating a method of attaching a substrate to a heat sink according to the present disclosure.

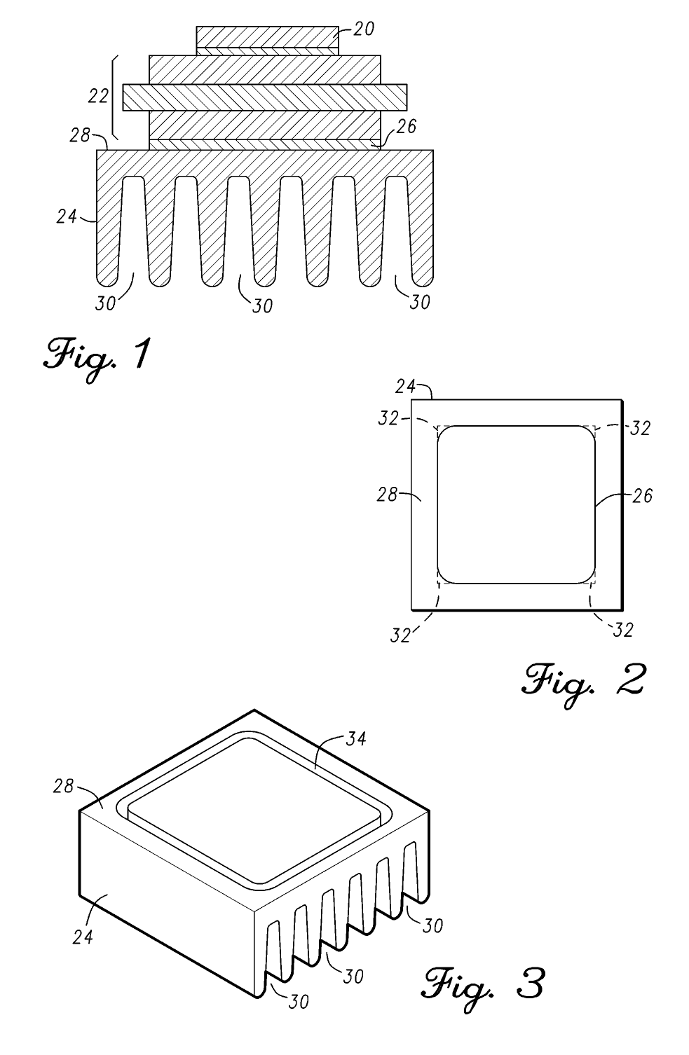

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

It has been observed that the strain force required to start the process of delamination of thermally conductive adhesive 26 from attachment surface 28 is greater than the force that is necessary to continue the delamination process once it has begun. Accordingly, one way to slow the delamination process discussed above is to interrupt the delamination process as the delamination of thermally conductive adhesive 26 propagates inwardly towards its center (the “delamination path”).

This interruption can be achieved by depositing thermally conductive adhesive 26 on attachment surface 28 in a manner that creates a discontinuity or gap in the layer of thermally conductive adhesive 26 along the delamination path. Thus, as the delamination of thermally conductive adhesive 26 propagates along the delamination path, when the delamination reaches the discontinuity, it will ceases to propagate and the delamination of thermally conductive adhesive 26 must start anew on the other side of the discontinuity. Because more cycles (time) are needed to re-start the delamination process than the cycles (time) needed to propagate the delamination process, the attached thermally conductive adhesive 26 on the other side of the discontinuity will offer a greater resistance to delamination than the resistance it would have offered had their been no discontinuity. This increased resistance retards the delamination process, extends the ability of heat sink 24 to extract heat from the electrical component, and extends the life of the electrical component.

The positioning of a discontinuity in the delamination path can be achieved in a number of ways. In some embodiments, the discontinuity can be created by depositing thermally conductive adhesive 26 onto attachment surface 28 in a pattern that creates the discontinuity by leaving designated areas of attachment surface 28 devoid of thermally conductive adhesive. When creating the discontinuity in this manner, care must be taken to ensure that the discontinuity is sufficiently wide so as to avoid the possibility of the differing segments of thermally conductive adhesive 26 from bridging the discontinuity when heat is applied to form the bond with substrate 22. At that point, thermally conductive adhesive 26 will liquefy and flow. If the discontinuity is sufficiently wide, the liquefied thermally conductive adhesive will not be able to bridge the discontinuity.

In another embodiment, one or more grooves may be formed in attachment surface 28 in any desirable pattern that intercepts the delamination path. Then, when thermally conductive adhesive 26 is deposited onto attachment surface 28, it is be deposited onto the portions of attachment surface 28 other than the groove or grooves. By depositing thermally conductive adhesive 26 in this manner, the discontinuity or discontinuities will coincide with the groove or grooves. As thermally conductive adhesive 26 is heated during the bonding process, any liquefied thermally conductive adhesive that flows in the direction of the discontinuity will fall into the groove, which acts as a spillway.

In another embodiment, a metal band or other suitable barrier may be disposed on attachment surface 28, or may be integrally formed therein, and positioned to intercept the delamination path. Thermally conductive adhesive 26 may then be deposited on opposite sides of the metal band or barrier. Accordingly, the metal band or barrier coincides with the discontinuity and obstructs thermally conductive adhesive 26 from bridging from one side of the discontinuity to the other.

In another embodiment, a combination of a metal band and a groove may be used. For example, one or more grooves may be defined in attachment surface 28 and a corresponding number of metal bands or other barriers may be inserted into the grooves. Thermally conductive adhesive 26 may then be deposited on opposite sides of the groove and metal band combination and the groove and metal band combination will serve as a barrier to obstruct thermally conductive adhesive 26 from bridging the discontinuity.

In yet another example, a thermally non-conductive adhesive, such as an epoxy, may be deposited on attachment surface 28 in a pattern that intercepts the delamination path. Thermally conductive adhesive 26 may then be deposited on opposite sides of the thermally non-conductive adhesive and obstructed thereby when heated during the bonding of substrate 22 to heat sink 24.

A further understanding of the attachment arrangement described above may be obtained through a review of the illustrations accompanying this application together with a review of the detailed description that follows.

With respect to FIGS. 3-5, an attachment arrangement 33 (see FIG. 5) for heat sink 24 is illustrated wherein a groove serves as a barrier to assist in the formation of a discontinuity in thermally conductive adhesive 26. As best seen in FIG. 3, heat sink 24 includes a groove 34 defined in attachment surface 28. Groove 34 may be defined in attachment surface 28 in any suitable manner known in the art including through the use of milling and machining techniques and through the use of cold forging.

In the illustrated embodiment, only a single groove is defined in attachment surface 28. As illustrated, groove 34 has a generally rectangular shape with rounded corners. This configuration mimics the anticipated pattern of delamination of thermally conductive adhesive 26 and thus groove 34 intercepts the delamination path. In other embodiments, any other desirable shape or configuration may be employed.

In still other embodiments, more than one groove may be defined in attachment surface 28. In one embodiment, four separate grooves may be defined in attachment surface 28, each being positioned along the delamination path from each of the four corners of attachment surface 28. In another embodiment, two or more concentric grooves may be defined in attachment surface 28 to provide multiple discontinuities.

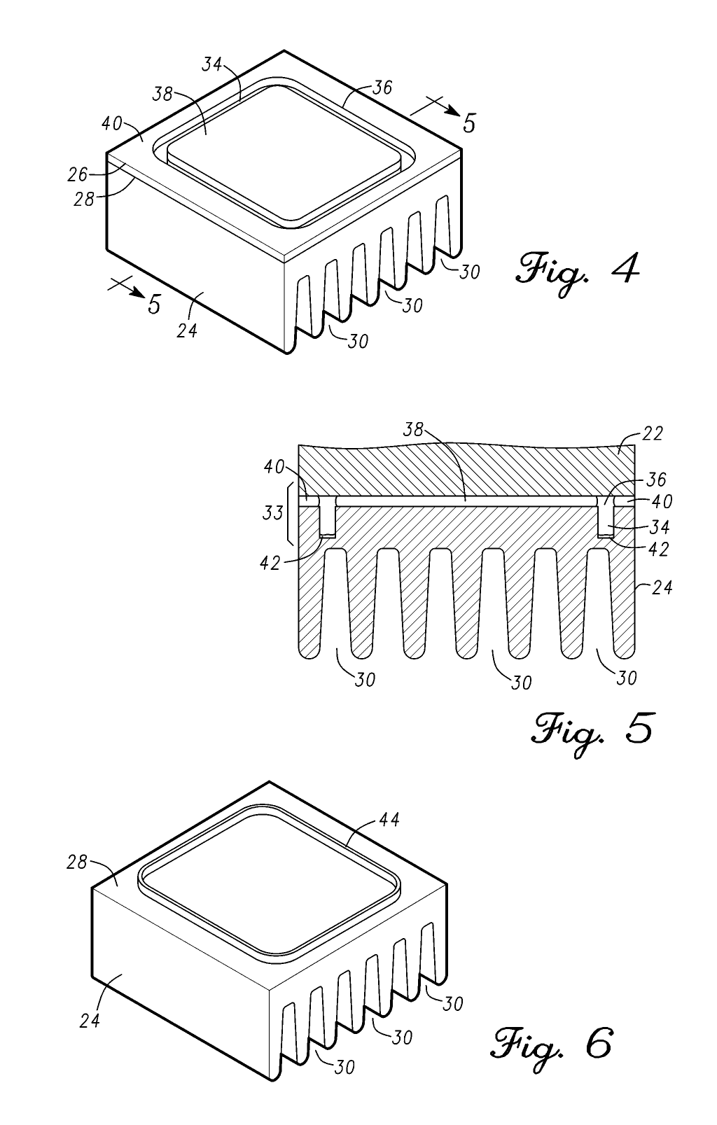

As best seen in FIG. 4, thermally conductive adhesive 26 has been deposited on attachment surface 28 in a pattern that positions a discontinuity 36 in the layer of thermally conductive adhesive 26 at substantially the same location as groove 34, when viewed from above heat sink 24. Discontinuity 36 serves to divide the layer of thermally conductive adhesive 26 into two segments, an inner segment 38 and an outer segment 40 that surround inner segment 38.

With respect to FIG. 5, a cross sectional view taken along the line 5-5 of FIG. 4 is illustrated. In this view, substrate 22 has been added to illustrate the attachment arrangement between heat sink 24 and substrate 22. As shown, groove 34 contains some spilled thermally conductive adhesive 42. This is because thermally conductive adhesive 26, when liquefied during the bonding process, flows into groove 34. In some embodiments, it may be desirable for groove 34 to have a depth equal to at least twice the anticipated thickness of the layer of thermally conductive adhesive 26 to accommodate spilled thermally conductive adhesive flowing from both inner segment 38 and outer segment 40. By accommodating spilled thermally conductive adhesive 42, groove 34 helps to maintain discontinuity 36 in the layer of thermally conductive adhesive 26. Thus, as the delamination process propagates along the delamination path, it will encounter discontinuity 36 and be interrupted. The delamination process will then have to begin anew with inner segment 38 on the other side of discontinuity 36. This stopping and restarting of the delamination process will slow down the delamination process and prolong the ability of heat sink 24 to draw heat from substrate 22.

With respect to FIGS. 6-8, an alternate embodiment of attachment arrangement 33 (see FIG. 8) which utilizes a metal band 44 to create discontinuity 36 is illustrated. As best seen in FIG. 6, metal band 44 is disposed on attachment surface 28. Metal band 44 have any desirable shape. In the illustrated embodiment, metal band 44 has the shape of a rectangle with rounded corners to mimic the delamination pattern. In other embodiments, rather than employing a single metal band, a plurality of metal band segments may be arranged in a pattern that intercepts the delamination path. In still other embodiments, a plurality of concentrically arranged metal bands may be employed. In still other embodiments, other types of raised barriers may also be used. For example, topographical features may be integrally molded into attachment surface 28 to serve as the barrier that forms discontinuity 36 and disrupts the delamination process.

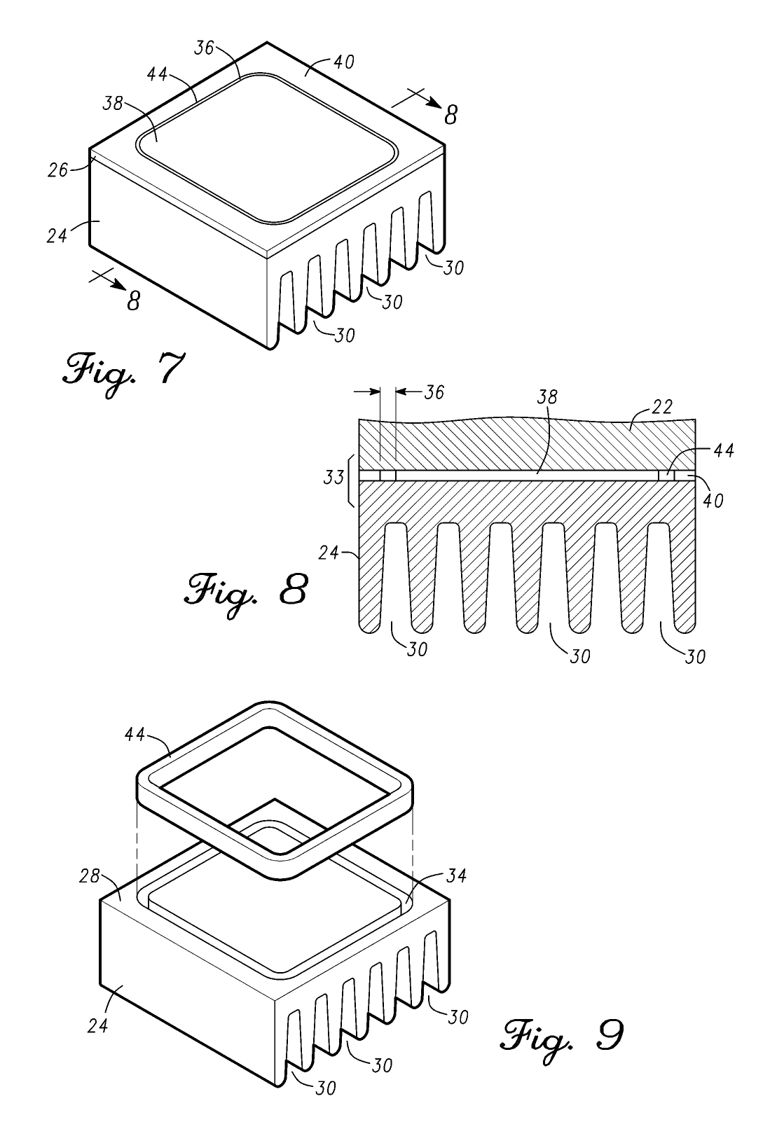

As best seen in FIG. 7, thermally conductive adhesive 26 has been deposited on attachment surface 28 on an area inside of metal band 44 and also on an area outside of metal band 44, thus forming inner segment 38 and outer segment 40, respectively. Metal band 44 serves to create discontinuity 36 between inner segment 38 and outer segment 40 and obstructs the flow of liquefied thermally conductive adhesive 26 during the bonding process.

With respect to FIG. 8, attachment arrangement 33 is illustrated between substrate 22 and heat sink 24. Metal band 44 has prevented the flow of liquefied thermally conductive adhesive 26 between inner segment 38 and outer segment 40 during the process of bonding substrate 22 to heat sink 24, and thus discontinuity 36 remains in tact. One advantage of utilizing metal band 44 to serve as the barrier in the delamination path is its ability to conduct heat away from substrate 22 due to its thermal conductivity and direct contact with substrate 22 and heat sink 24.

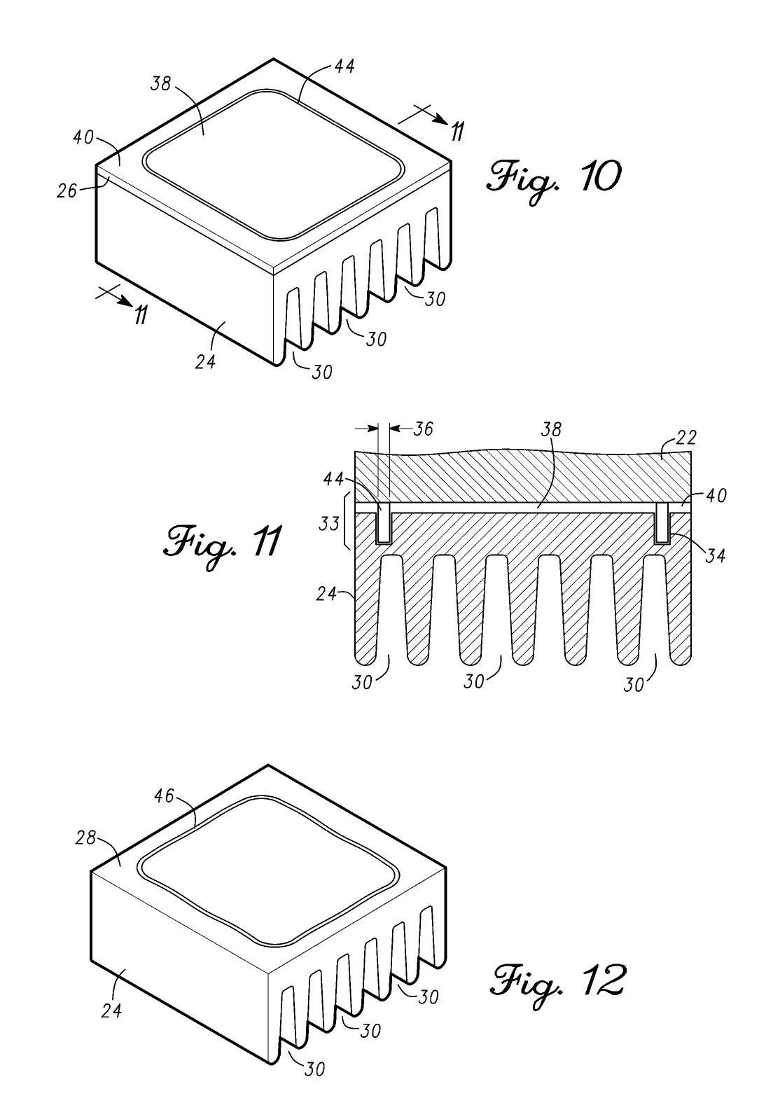

With respect to FIGS. 9-11, another embodiment of attachment arrangement 33 (see FIG. 11) is illustrated employing a combination of groove 34 and metal band 44. As best seen in FIG. 9, once groove 34 is defined in attachment surface 28, metal band 44 may be disposed within groove 34. This embodiment may provide greater control in the positioning and maintenance of metal band 44 on attachment surface 28 and may also provide a more robust obstacle to the flow of liquefied thermally conductive adhesive than is provided by either metal band 44 or groove 34 acting alone.

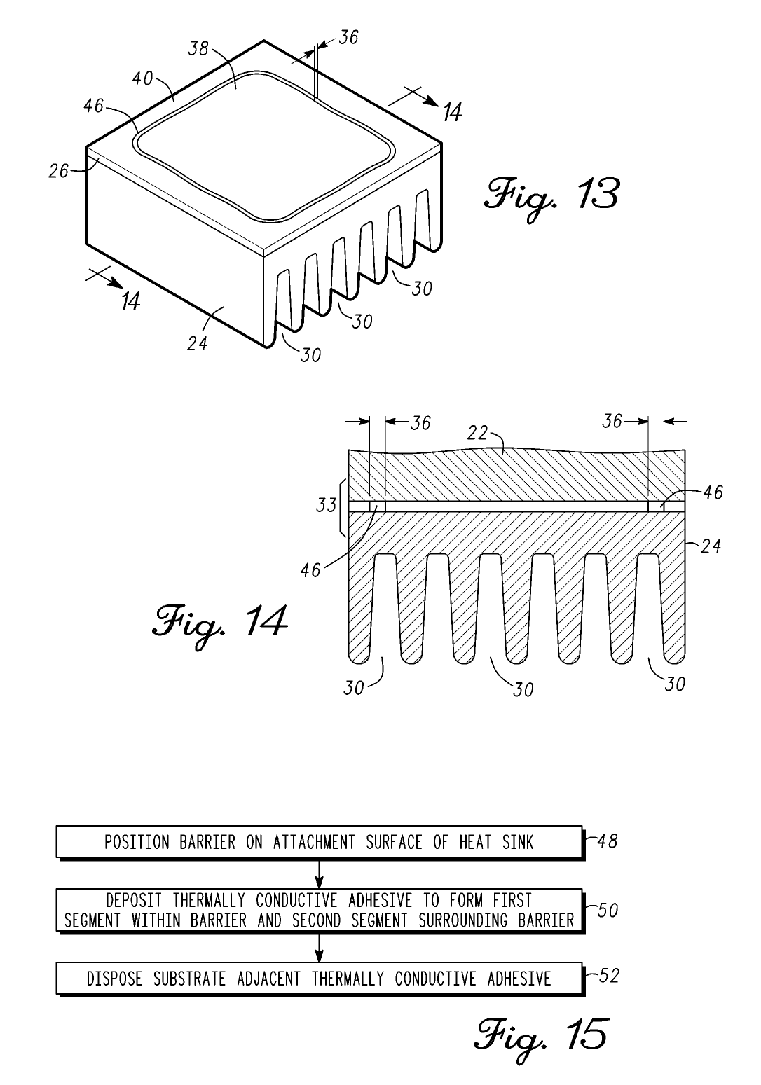

With respect to FIGS. 12-14, another embodiment of attachment arrangement 33 (see FIG. 14) is illustrated. A thermally non-conductive adhesive barrier 46 is illustrated disposed on attachment surface 28. Thermally non-conductive adhesive barrier 46 may comprise any adhesive having a relatively low ability to conduct heat, such as any type of glue or epoxy. In FIG. 12, thermally non-conductive adhesive barrier 46 is configured as a rectangle with rounded corners to mimic the pattern of delamination. In other embodiments, thermally non-conductive adhesive 46 may have any other suitable configuration. In still other embodiments, thermally non-conductive adhesive 46 may be deposited on attachment surface 28 in a pattern that forms a plurality of segments, each segment intercepting the delamination path of thermally conductive adhesive 26.

With respect to FIG. 13, thermally conductive adhesive 26 has been deposited on attachment surface 28 in a pattern forming inner segment 38 and outer segment 40, with thermally non-conductive adhesive barrier 46 disposed between the two segments. In this manner, the positioning of thermally non-conductive adhesive barrier 46 coincides with discontinuity 36 and will serve to obstruct the flow of thermally conductive adhesive 26 during the bonding process.

With respect to FIG. 14, a cross-sectional view taken across the line 14-14 of FIG. 13 is illustrated. FIG. 14 illustrates attachment arrangement 33 between substrate 22 and heat sink 24. As illustrated, thermally non-conductive adhesive barrier 46 obstructed the flow of thermally conductive adhesive 26 to maintain discontinuity 36 during the process of bonding substrate 22 to heat sink 24. The illustrated configuration has the benefit of providing added adhesive between substrate 22 and heat sink 24 than is provided by the previously discussed embodiments. The provision of this additional adhesive may further retard the delamination process.

With respect to FIG. 15, a block diagram illustrates a method for attaching substrate 22 to heat sink 24 is illustrated. At block 48, a barrier is positioned on attachment surface 28 of heat sink 24. The barrier may take any of the forms discussed above as well as any other barrier suitable to prevent liquefied thermally conductive adhesive 26 from flowing across discontinuity 36. In some embodiments, the barrier may take the shape of a rectangle having rounded corners while in other embodiments, the barrier may have any suitable configuration.

At block 50, thermally conductive adhesive 26 is deposited on opposite sides of the barrier. In some embodiments, such as those where the barrier takes the shape of a rectangle having rounded corners, thermally conductive adhesive 26 will form inner segment 38 within the barrier and outer segment 40 surrounding the barrier.

At block 52, substrate 22 is positioned adjacent the barrier and thermally conductive adhesive 26. Thermally conductive adhesive 26 may then be heated to allow it to liquefy and form a bond with substrate 22.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. An attachment arrangement for a heat sink, the attachment arrangement comprising:
an attachment surface defined on the heat sink;
a thermally conductive adhesive disposed on the attachment surface; and
a substrate attached to the attachment surface via the thermally conductive adhesive,
wherein the thermally conductive adhesive defines a discontinuity disposed in a delamination path of the thermally conductive adhesive.

2. The attachment arrangement of claim 1, wherein the thermally conductive adhesive comprises two segments, wherein one of the segments surrounds another of the segments to form an inner segment and an outer segment and wherein the inner segment and the outer segment are separated by the discontinuity.

3. The attachment arrangement of claim 2, wherein the inner segment has a generally rectangular configuration having rounded corners.

4. The attachment arrangement of claim 2, wherein the discontinuity has a generally rectangular configuration with rounded corners.

5. The attachment arrangement of claim 1, wherein the thermally conductive adhesive comprises solder.

6. An attachment arrangement for a heat sink, the attachment arrangement comprising:
an attachment surface defined on the heat sink;
a thermally conductive adhesive disposed on the attachment surface, the thermally conductive adhesive comprising a plurality of segments, each of the segments being spaced apart from one another;
a barrier disposed between each segment of the plurality of segments; and
a substrate attached to the attachment surface via the thermally conductive adhesive.

7. The attachment arrangement of claim 6, wherein the barrier comprises a groove defined in one of the attachment surface and the substrate.

8. The attachment arrangement of claim 7, wherein the groove has a depth approximately equal to twice a thickness of the thermally conductive adhesive.

9. The attachment arrangement of claim 6, wherein the barrier comprises a non-thermally conductive adhesive.

10. The attachment arrangement of claim 6, wherein the barrier comprises a metallic band.

11. The attachment arrangement of claim 6, wherein the barrier comprises a groove defined in a surface of one of the attachment surface and the substrate and further comprises a metal band disposed within the groove.

12. The attachment arrangement of claim 6, wherein the barrier divides the plurality of segments into an inner segment and an outer segment.

13. The attachment arrangement of claim 12, wherein the barrier has a generally rectangular configuration having rounded corners.

14. The attachment arrangement of claim 12, wherein the barrier comprises a metal band.

15. The attachment arrangement of claim 12, wherein the barrier comprises a groove defined in one of the attachment surface and the substrate.

16. The attachment arrangement of claim 15, wherein the barrier further comprises a metal band disposed within the groove.

17. The attachment arrangement of claim 6 wherein the thermally conductive adhesive comprises solder.

18. A method for attaching an item to a heat sink, the method comprising the steps of:
positioning a barrier on an attachment surface of the heat sink;
depositing a thermally conductive adhesive on the attachment surface of the heat sink in a pattern that forms a first segment enclosed within the barrier and a second segment surrounding the barrier; and
disposing a substrate adjacent the thermally conductive adhesive.

19. The method of claim 18, wherein the positioning step comprises defining a groove in the attachment surface.

20. The method of claim 19, wherein the positioning step comprises placing a metal band on the attachment surface.
